(19) United States
(12) Patent Application Publication
(10) Pub. No.: US 2024/0154139 A1
(43) Pub. Date: May 9, 2024

(54) HYDROGEN RECIRCULATION TURBOCHARGER

(71) Applicant: Joby Aero, Inc., Santa Cruz, CA (US)

(72) Inventor: Robert Gulliver Lynn, Auckland (NZ)

(21) Appl. No.: 18/503,498

(22) Filed: Nov. 7, 2023

Related U.S. Application Data
(60) Provisional application No. 63/382,764, filed on Nov. 8, 2022.

(51) Int. Cl. H01M 8/04111; H01M 8/04082; H01M 8/04089

(52) U.S. Cl. CPC H01M 8/04111; H01M 8/04104; H01M 8/04201

(57) ABSTRACT

A hydrogen circulation system for use with a fuel cell stack includes a supply line for receiving hydrogen gas from a supply of hydrogen, a fuel cell for receiving hydrogen gas from the supply line, an excess hydrogen line for receiving excess hydrogen from the fuel cell, and a turbocharger coupled to the excess hydrogen line and the supply line, to receive excess hydrogen from the excess hydrogen line, compress it, and return it to the supply line, the turbocharger being powered in use by hydrogen gas from the supply line.

### RELATED APPLICATION DATA

This application claims the benefit of U.S. Provisional Patent Application No. 63/382,764 filed on Nov. 8, 2022, the contents of which are incorporated herein by reference as if explicitly set forth.

### TECHNICAL FIELD

This invention relates generally to the field of fuel cells fueled by liquid hydrogen, including for example for use in electrically-powered or hybrid-powered aircraft.

### BACKGROUND

Fuel cell vehicles are powered by compressed hydrogen gas that is fed into an onboard fuel cell “stack,” which transforms the hydrogen's chemical energy into electrical energy. This electricity is then available to power the vehicle and its onboard systems.

Hydrogen supplied to a fuel cell enters the anode, where it comes in contact with a catalyst that promotes the separation of hydrogen atoms into an electron and proton. The electrons are gathered by the conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of an aircraft according to some examples.

FIG. 2 is a schematic view of an aircraft energy system according to some examples.

FIG. 3 is a schematic diagram illustrating a hydrogen recirculation system for use in the aircraft of FIG. 1, according to some examples.

FIG. 4 is a schematic cross section through a separator and a turbocharger, according to some examples.

FIG. 5 shows an early form of steam engine, known as an aeolipile.

FIG. 6 is a schematic diagram illustrating an expansion module including an aeolipile, according to some examples.

FIG. 7 is a schematic cross section through a separator and a turbocharger, according to some examples.

FIG. 8 is a schematic diagram illustrating a hydrogen recirculation system for use in the aircraft of FIG. 1, according to some examples.

FIG. 9 is a flowchart illustrating operation of the hydrogen recirculation system of FIG. 3 or FIG. 8, according to some examples.

FIG. 10 is a flowchart illustrating operation of the hydrogen recirculation system of FIG. 3 or FIG. 8, according to some examples.

FIG. 11 illustrates a diagrammatic representation of a machine in the form of a computer system within which a set of instructions may be executed for causing the machine to perform any one or more of the methodologies discussed herein, according to some examples.

### DETAILED DESCRIPTION

The following description of examples of the invention is not intended to limit the invention to these examples, but rather to enable any person skilled in the art to make and use this invention.

Fuel cells require that hydrogen be recirculated. Current pumps for this purpose are large and inefficient, and pump choices are limited by the fact that hydrogen cannot be allowed to come into contact with traditional lubricants. Particularly in the aviation field, the mass and energy consumption of a pump for recirculating the hydrogen can be a disadvantage, since this reduces available payload as well as reducing the range of an aircraft.

Disclosed is a fuel cell hydrogen circulation system. The fuel cell is supplied with hydrogen via a supply line from a supply of hydrogen, such as a tank. Excess hydrogen from the fuel cell leaves the fuel cell via an excess hydrogen line and is received by a turbocharger, which compresses it and returns it to the supply line. The turbocharger is powered in use by hydrogen gas from the supply line. The expansion of the hydrogen gas from the supply line is thus exploited to compress the excess hydrogen gas from the fuel cell before it is returned to the fuel cell.

The following description of examples of the invention is not intended to limit the invention to these examples, but rather to enable any person skilled in the art to make and use this invention.

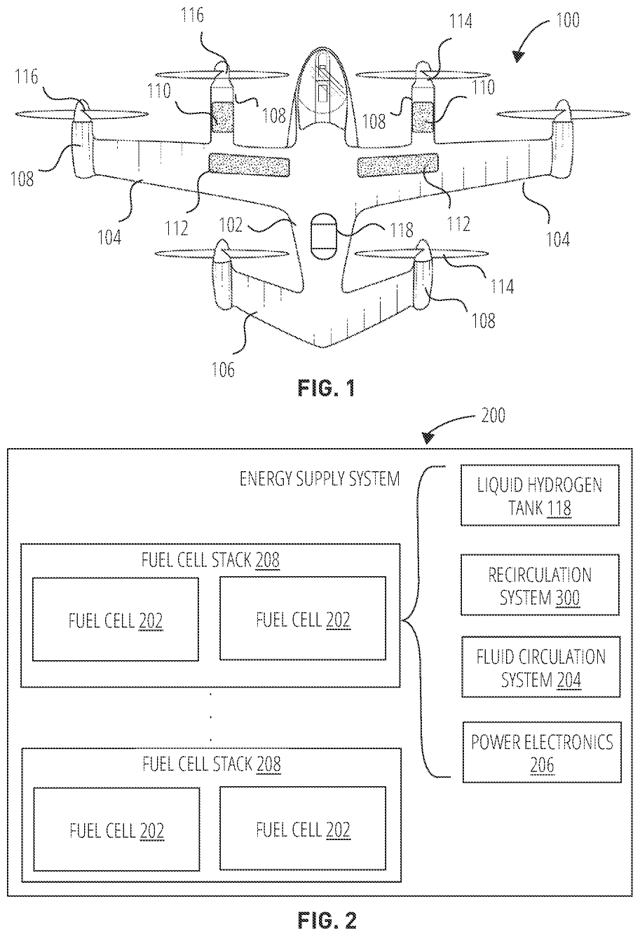

FIG. 1 is a plan view of an aircraft 100 according to some examples. The aircraft 100 includes a fuselage 102, two wings 104, an empennage 106 and propulsion systems 114 embodied as tiltable rotor assemblies 116 located in nacelles 108. The aircraft 100 includes one or more a nonlinear power sources embodied in FIG. 1 as nacelle fuel cell stacks 110 and wing fuel cell stacks 112. The aircraft 100 will typically include associated equipment such as an electronic infrastructure, control surfaces, a cooling system, landing gear and so forth.

The wings 104 function to generate lift to support the aircraft 100 during forward flight. The wings 104 can additionally or alternately function to structurally support the fuel cell stacks 110, 112 and/or propulsion systems 114 under the influence of various structural stresses (e.g., aerodynamic forces, gravitational forces, propulsive forces, external point loads, distributed loads, and/or body forces, and so forth).

It is to be understood that the fuel cell powertrain can in other examples analogously be implemented with alternative types of powertrain architectures, such as a hybrid battery electric and hydrogen fuel-cell powertrain architecture.

FIG. 2 is a schematic view of an aircraft energy supply system 200 according to some examples. As shown, the energy supply system 200 includes one or more fuel cell stacks 208. Each fuel cell stack 208 may include one or more fuel cells 202.

Typically associated with a fuel cell stack 208 are a source of hydrogen such as a liquid hydrogen tank 118, a recirculation system 300 for supplying and returning hydrogen to the fuel cell stack 208, a fluid circulation system 204 for transferring heat, and power electronics 206 for regulating delivery of electrical power from the fuel cell stacks 208 during operation and to provide integration of the fuel cell stacks 208 with the electronic infrastructure of the aircraft 100.

The electronic infrastructure can include an energy supply management system, for monitoring and controlling operation of the fuel cell stacks 208.

The fuel cell stacks 208 function to convert chemical energy into electrical energy for supply to the propulsion systems 114. Fuel cell stacks 208 can be arranged and/or distributed about the aircraft in any suitable manner. Fuel cell stacks can be arranged within wings (e.g., inside of an airfoil cavity), inside nacelles, and/or in any other suitable location on the aircraft.

The energy supply system 200 can optionally include a heat transfer system (e.g., fluid circulation system 204) that functions to transfer heat from or to various components of the aircraft 100, for example by circulating a working fluid within a fuel cell stack 208 to remove heat generated during operation, to provide heat for evaporation of liquid hydrogen from the liquid hydrogen tank 118, or to remove heat from other heat-generating components within the aircraft 100.

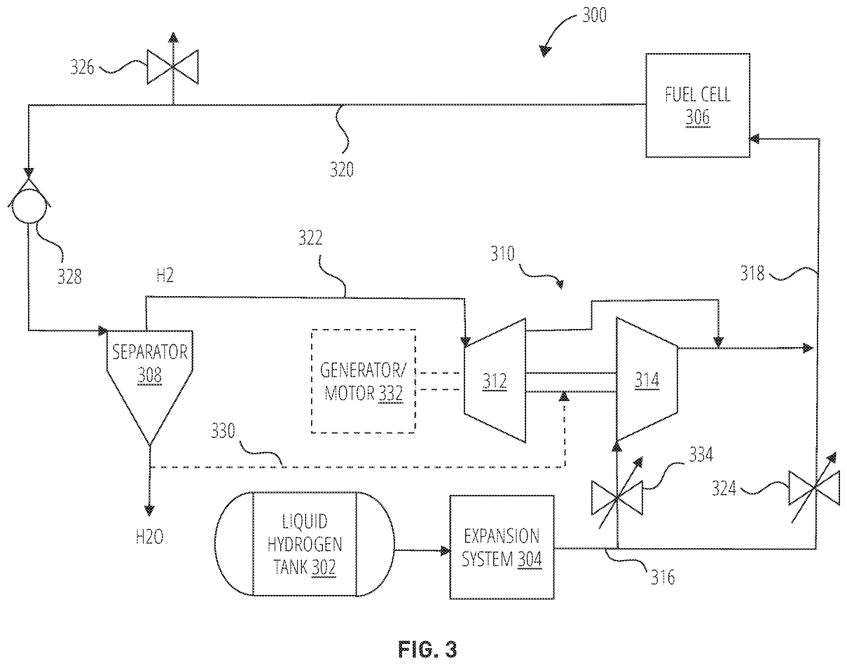

FIG. 3 is a schematic diagram illustrating a hydrogen recirculation system 300 for use in the aircraft 100, according to some examples. The recirculation system 300 comprises a liquid hydrogen tank 302, an expansion system 304, a fuel cell 306, a separator 308 and a turbocharger 310. The components of the hydrogen recirculation system 300 are connected by supply lines 316, 318, 320 and 322 as shown in FIG. 3.

The liquid hydrogen tank 302, as its name suggests, stores liquid hydrogen for use in the fuel cell 306. The liquid hydrogen tank 302 is connected to, and supplies liquid hydrogen to the expansion system 304. The expansion system 304 includes a pump that pressurizes the liquid hydrogen and a heat exchanger that evaporates and expands the liquid hydrogen approximately to the temperature required by the fuel cell 306, and to a pressure above that required by the fuel cell 306. Hydrogen gas leaving the expansion system 304 via supply line 316 is provided to the fuel cell 306 via a control valve 324, and to the turbocharger 310 via a control valve 334. The control valve 324 serves to regulate the pressure of the hydrogen gas supplied to the fuel cell 306 to a nominal fuel cell supply pressure. The control valve 334 serves to regulate the pressure of the hydrogen gas supplied to the turbocharger 310, which regulates the speed of and compression provided by the turbocharger 310.

Hydrogen and compressed air (not shown) are supplied to the fuel cell 306. An excessive supply of hydrogen is generally required for high power vehicular applications. The excess hydrogen that is not consumed by the fuel cell is thus recycled through the recirculation system 300. Excess hydrogen leaving the fuel cell 306 typically includes some water vapor and an accumulation of nitrogen. Hydrogen leaving the fuel cell 306 via supply line 320 can periodically be purged through a purge valve 326 located downstream from the fuel cell 306. A check valve 328 may be provided downstream of the purge valve 326 in supply line 320 to prevent the flow in the recirculation system 300 from reversing during purging.

Excess hydrogen leaving the fuel liquid hydrogen tank 118 is provided to the separator 308, where liquid water in the excess hydrogen is removed and discharged. In some examples, in which the turbocharger 310 includes a water bearing, waste water may be supplied to the turbocharger 310 by a water supply line 330. Hydrogen leaving the separator is provided to the turbocharger 310 via supply line 322.

The turbocharger 310 includes a compressor 312 and a turbine 314. The turbine 314 is driven by the pressure differential between the hydrogen gas leaving the expansion system 304 (supply line 316) and the hydrogen gas supplied to the fuel cell 306 (supply line 318). The turbine 314 in turn drives the compressor 312, which compresses the excess hydrogen gas received from the separator 308 (supply line 322) to the pressure of the hydrogen gas supplied to the fuel cell 306 (supply line 318). Hydrogen gas leaving the compressor 312 joins the hydrogen gas leaving the turbine 314 and both join the hydrogen gas supplied to the fuel cell 306 from the expansion system 304 via the control valve 324.

The pressure of the hydrogen gas supplied to the turbocharger 310 from the expansion system 304 may be approximately 2.7 bar, the pressure of the hydrogen gas supplied to the fuel cell 306 may be approximately 2.2 bar, and the pressure of the excess hydrogen gas leaving the fuel cell 306 may be approximately 2.0 bar, in some examples. The diameter of the turbine 314 is between 15 and 20 mm and spins at approximately 500,000 rpm, in some examples.

In some examples, a generator/motor 332 is coupled to the turbocharger 310. When functioning as a generator, the generator/motor 332 generates additional electrical power for use in an aircraft including the recirculation system 300. The speed of the turbocharger 310 can also be controlled by adjusting the load on the generator/motor 332. When functioning as motor, the generator/motor 332 boosts operation of the turbocharger 310 by replacing or supplementing the torque supplied to the compressor 312 by the turbine 314, for example in the case of a drop in the pressure of the hydrogen gas supplied to the turbocharger 310 or other pressure fluctuations in the system. When functioning as a generator, the generator/motor 332 retards operation of the turbocharger 310 by absorbing some of the torque supplied to the compressor 312 by the turbine 314.

In use, hydrogen gas from the liquid hydrogen tank 302 is provided to the turbocharger 310 and the fuel cell 306 via the expansion system 304. The pressure of the hydrogen gas supplied to the fuel cell 306 (supply line 318) is regulated by the control valve 324. Hydrogen gas supplied to the turbocharger 310 (supply line 316), regulated by control valve 334, spins the turbine 314 and is then provided to the fuel cell 306 (supply line 318). The turbine 314 turns the compressor 312, which draws in excess hydrogen gas from the separator 308 (supply line 322), compresses it and provides it to the fuel cell 306 (supply line 318).

Excess hydrogen gas leaves the fuel cell 306 via supply line 320, passes through the check valve 328 and arrives at the separator 308, which separates and discharges water from the excess hydrogen gas. The excess hydrogen gas is then drawn into the turbocharger 310 by the compressor 312 (supply line 322).

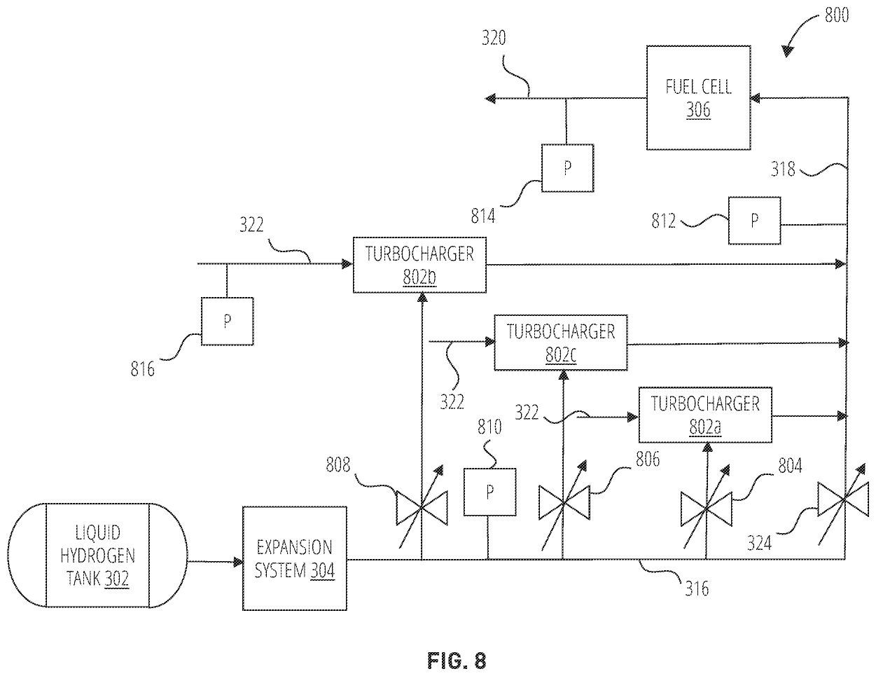

Also included in the supply lines 316, 318, 320, 322 are pressure sensors that provide output signals corresponding to the pressures in the different supply lines, see further FIG. 8. The outputs of the pressure sensors are provided to a fuel cell management system that is part of the power electronics 206.

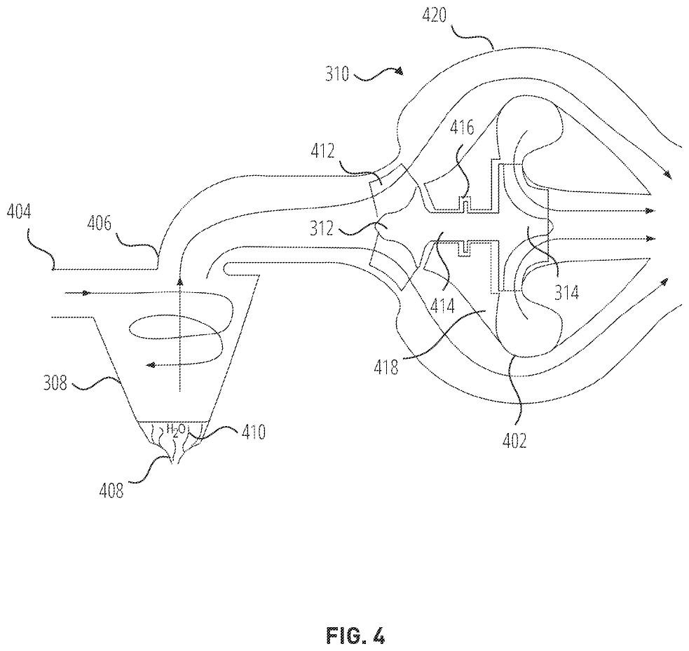

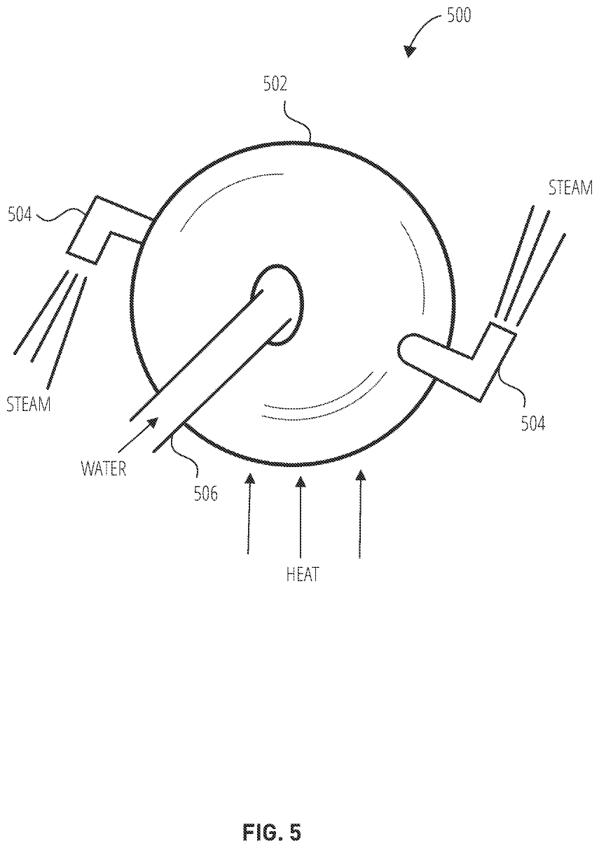

FIG. 4 is a schematic cross section through a separator 308 and a turbocharger 310, according to sonic examples. Excess hydrogen gas enters the separator 308 circumferentially at its inlet 404 and spins inside the separator 308. Centrifugal forces urge the water or water vapor in the excess hydrogen gas to the side of the separator 308, where it runs down towards a drain 408. Collected water 410 then leaves the separator 308 via the drain 408. The drier, excess hydrogen gas leaves the separator 308 from a central outlet 406 and is passed to the turbocharger 310.

The turbocharger 310 includes a body 418, a housing 420 and the compressor 312 and the turbine 314, which are joined by a shaft 414. The shaft 414 is supported for rotation relative to the housing in a bearing 416. In some examples, the bearing 416 is a gas-lubricated bearing 416 in which the gas is the hydrogen gas found in and supplied to the turbocharger 310 from the separator 308 or the expansion system 304. In other examples, the bearing 416 is a liquid-lubricated bearing, in some examples a water-lubricated bearing in which the water is supplied by the separator 308.

Hydrogen gas from the separator 308 is drawn into the turbocharger 310 by the compressor 312, which in the illustrated example is a mixed-flow impeller, but could also be a radial or axial impeller. The vanes 412 of the compressor 312 in some examples have a variable pitch, which can be adjusted by the fuel cell management system in the power electronics 206 to provide a variable increase in pressure across the turbocharger 310. Higher pressure hydrogen gas leaving the compressor 312 passes around the turbine 314 in passages in the housing 420, and joins the hydrogen gas leaving the turbine 314.

The turbine 314 in the illustrated example is a radial inflow turbine located in a volute 402, which receives a supply of hydrogen gas from the expansion system 304. After spinning the turbine 314, the hydrogen gas leaving the turbine 314 joins the hydrogen gas from the compressor 312, which in turn join the hydrogen gas from the control valve 324 in the supply line 318.

In some examples, the compressor 312 and/or the turbine 314 have multiple stages, to reduce gas flow speeds and impeller tip speeds and thereby enable larger lower rpm impellers that are easier to manufacture.

FIG. 5 illustrates an early form of steam engine, known as an aeolipile 500. The aeolipile 500 comprises a spherical vessel 502, an inlet 506 and two nozzles 504. Water is supplied to the vessel 502 via the inlet 506. The vessel is heated (typically over a fire), vaporizing the water in the vessel 502 into steam. The steam exits the nozzles 504 at high speed, the reaction to which causes the vessel 502 to rotate. In some examples, the turbocharger 310 can be embodied as an aeolipile.

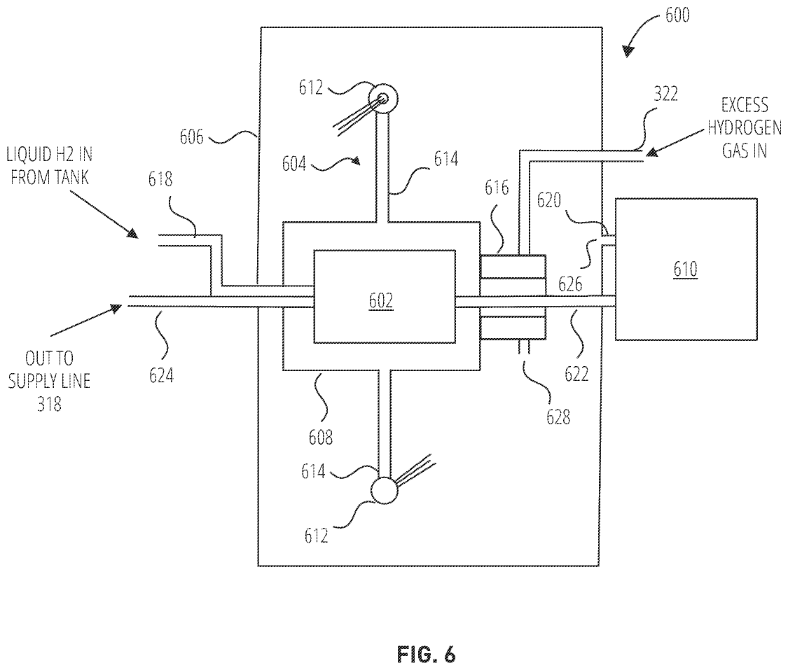

FIG. 6 is a schematic diagram illustrating a turbocharger 600, according to some examples. The turbocharger 600 includes an aeolipile 604 located inside a module housing 606, a heat exchanger 602 located inside the aeolipile 604 and a pump 610 to receive hydrogen gas expelled from the aeolipile 604 and to return it to the heat exchanger 602. Also included is a compressor 616 mechanically powered by rotation of the aeolipile 604, and pipes 618, 620, 622 and 624 to route the hydrogen through the turbocharger 600.

The aeolipile 604 comprises an aeolipile housing 608, tubes 614 that are in fluid communication with the inside of the aeolipile housing 608, and which direct hydrogen gas to nozzles 612 to rotate the aeolipile 604 within the module housing 606. The aeolipile 604 is rotationally coupled to the module housing 606, for example by means of hollow shafts located in bearings or bushings (not shown) on each side of the aeolipile housing 608. Evaporated and expanding hydrogen gas is supplied to the interior of the aeolipile housing 608 from holes in the heat exchanger 602.

The compressor 616 receives excess hydrogen gas from the fuel cell 306, compresses it and releases the compressed hydrogen gas into the module housing 606 via an outlets 628, where it combines with hydrogen gas leaving the aeolipile 604.

In use, expanding hydrogen gas leaves the heat exchanger 602, passes through the aeolipile housing 608 and the tubes 614, and leaves the aeolipile 604 through the nozzles 612, rotating the aeolipile 604 and an impeller of the compressor 616, which in turn compresses the excess hydrogen gas received from the supply line 322. In some examples, the compressor 616 also includes an electrical generator, which generates electrical power from the rotation of the aeolipile 604 and that is provided to the aircraft's electrical system. Hydrogen ejected from the nozzles 612 is initially contained by the module housing 606, and together with the compressed excess hydrogen gas leaving the compressor 616, then exits via an outlet 626 into a pipe 620 that supplies the expanded hydrogen to the pump 610. The pump 610 serves to return the expanded hydrogen gas and compressed excess hydrogen to the heat exchanger 602 via a pipe 622.

The heat exchanger 602, via pipe 618, is supplied with pressurized liquid hydrogen from the expansion system 304 via the control valve 334. Warmer, expanded hydrogen gas returns to the heat exchanger 602 from the pump 610 via a pipe 622, passes through a radiator core (not shown) inside the heat exchanger 602, where it is cooled by the hydrogen supplied to the heat exchanger 602 by the pipe 618, before leaving to the supply line 318 of the fuel cell 306 via pipe 624.

In use, the hydrogen supplied by the pipe 618 flows onto or around the radiator core inside the heat exchanger 602, where it is heated, evaporates if in liquid form, and expands. Expanding hydrogen gas leaves the heat exchanger 602 and passes into the aeolipile housing 608 through holes in the heat exchanger 602. Expanding hydrogen gas leaving the aeolipile 604 via the nozzles 612 turn the aeolipile 604 against the resistance of the compressor 616.

Hydrogen gas leaving the module housing 606 via pipe 620 is returned to the heat exchanger 602 by pump 610 via pipe 622. The returning hydrogen is cooled by transferring heat to the supply hydrogen entering the heat exchanger 602 from pipe 618, as the returning hydrogen passes through the radiator core in the heat exchanger 602. The returning hydrogen then leaves the turbocharger 600 via pipe 624 to the supply line 318 of the fuel cell 306.

The evaporation and expansion of the liquid hydrogen in the liquid hydrogen tank 302 to the pressure and temperature of required by the fuel cell 306 thus be used to compress the excess hydrogen gas and optionally generate additional electrical power. This reduces the electrical load on the fuel cell 306, with corresponding increases in efficiency, range and so forth.

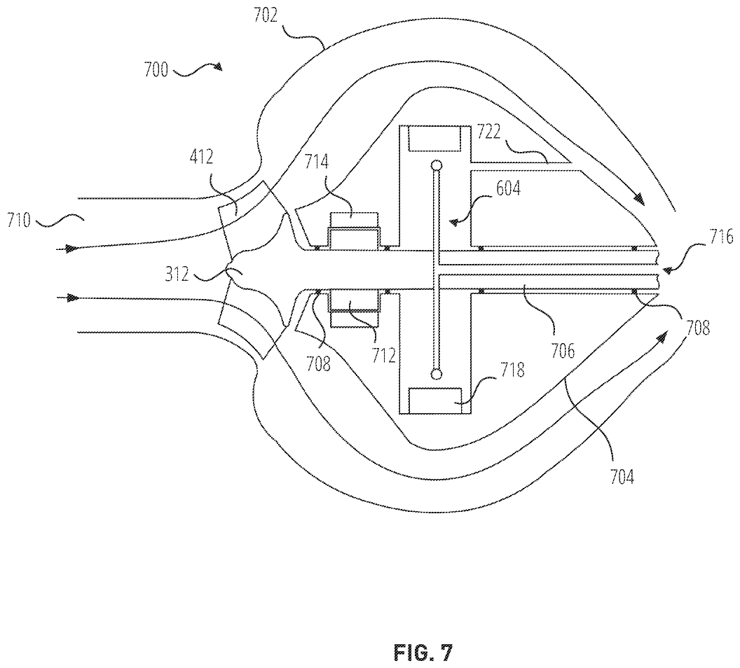

FIG. 7 is a schematic cross section through a turbocharger 700 including an aeolipile 604, according to some examples.

The turbocharger 700 includes a body 704, a housing 702 and a compressor 312 and the aeolipile 604, which are joined by a shaft 706. The shaft 706 is supported for rotation relative to the housing using several seals and bearings 708 and an appropriate rotational coupling between the shaft 706 and the supply line 316.

As in FIG. 6, hydrogen gas from the separator 308 is drawn into the turbocharger 700 at inlet 710 by the compressor 312, which in the illustrated example is a mixed-flow impeller, but could also be a radial or axial impeller. The vanes 412 of the compressor 312 in some examples have a variable pitch, which can be adjusted by the fuel cell management system in the power electronics 206 to provide a variable increase in pressure across the turbocharger 310. Higher pressure hydrogen gas leaving the compressor 312 passes around the aeolipile 604 and exits the turbocharger 700 to return to the fuel cell 306 via the supply line 318.

The turbocharger 700 includes a generator/motor 332 (see FIG. 3 and associated descriptions) comprising a rotor 712 and a stator 714.

The aeolipile 604 is supplied with hydrogen from the expansion system 304 through a bore 716 defined in the shaft 706. As before, hydrogen exiting the aeolipile 604 spins the shaft 706 to turn the compressor 312 and the rotor 712 of the generator/motor 332. Hydrogen leaving the aeolipile 604 interacts with a radial diffuser 718 located around the aeolipile 604 in the body 704 of the turbocharger 700. This reduces rotation of the hydrogen within the housing. Hydrogen from the aeolipile 604 then joins the hydrogen that has been compressed by the compressor 312 via a conduit 722 in the body 704 of the turbocharger 700.

In some examples, the hydrogen leaving the aeolipile 604 is routed to a heat exchanger before joining the hydrogen that has been compressed by compressor 312, in order to exploit a temperature difference between the hydrogen leaving the aeolipile 604 and another fluid. In some examples, this hydrogen is passed to the heat exchanger 602 to warm up the liquid hydrogen arriving from the expansion system 304 as discussed above with reference to FIG. 6. In other examples, the hydrogen leaving the aeolipile 604 is routed to a heat exchanger located in an air inlet and compressor for supplying air to the fuel cell 202, to cool the air before or after it is compressed for use by the fuel cell 202.

FIG. 8 is a schematic diagram illustrating a hydrogen recirculation system 800 for use in the aircraft 100, according to some examples. The recirculation system 800 is substantially identical to recirculation system 300, with the exception that multiple turbochargers 802a, 802b, 802c etc., are provided. For purposes of efficiency and clarity, not all of the components of recirculation system 800 are illustrated in FIG. 8.

FIG. 8 also shows a pressure sensor 810 on supply line 316, a pressure sensor 812 on supply line 318, a pressure sensor 814 on supply line 320 and a pressure sensor 816 on supply line 322. Pressure sensors 810, 812, 814 and 816 provide signals representing the pressure in their respective supply lines, to a fuel cell management system that is part of the power electronics 206.

As before, hydrogen gas leaving the expansion system 304 via supply line 316 is provided to the fuel cell 306 via a control valve 324, and to the turbochargers 802a, 802b, 802c via a control valves 804, 806 and 808 respectively. The control valve 324 serves to regulate the pressure of the hydrogen gas supplied to the fuel cell 306, while the control valves 804, 806 and 808 serve to regulate the pressure of the hydrogen gas supplied to the turbochargers 802a, 802b, 802c. The control valves 324, 804, 806 and 808 are controlled by control signals received from the power electronics 206, based in part on the pressures reported by the pressure sensors 810, 812, 814 and 816.

A single turbocharger 310 may have an insufficient range of operation to provide circulation of hydrogen gas through the recirculation system 800 in all situations. If for example there is a decrease in the pressure in supply line 316, a decrease in pressure in supply line 322, or an increase in pressure in supply line 318, a single turbocharger 802a may not be able to provide a sufficient pressure differential in the system to circulate the hydrogen gas as required. In such a case, one or more additional turbochargers 802b, turbocharger 802c may be brought online by opening their respective control valves 806, 808 under control of the power electronics 206.

Additionally, in response to a situation that would result in increased pressures or flows, for example an increase in the pressure in supply line 316, which would tend to increase the speed of the turbochargers 802a, 802b and 802c and hence increase the pressure in supply line 318, one or more of the turbochargers can be shut down by closing their control valves, or one or more of the control valves could be partially closed to reduce the pressure of the hydrogen gas provided to the supply line 318.

Finer control of the pressure and flow delivered by the turbochargers 802a, 802b, 802c can also be provided by partially opening or closing of the control valves 804, 806 and 808 in response to changing hydrogen pressure conditions in the recirculation system 800.

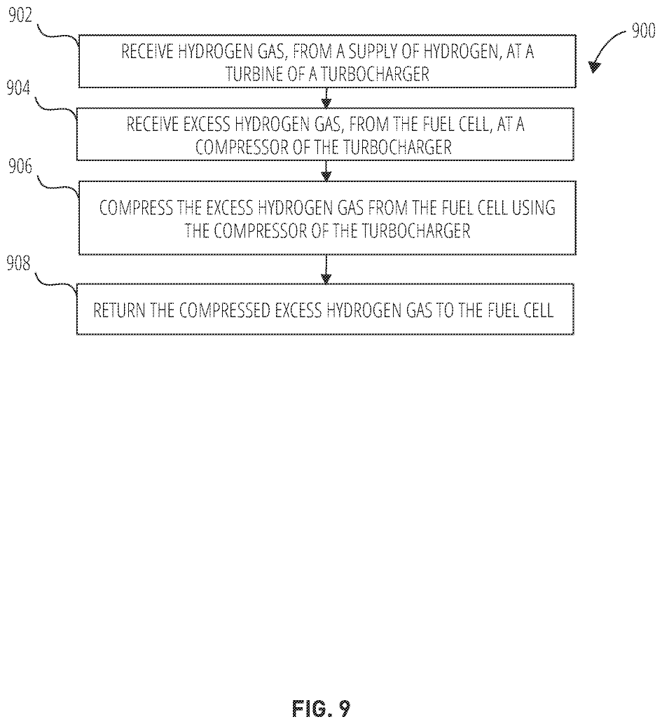

FIG. 9 is a flowchart 900 illustrating operation of the hydrogen recirculation system of FIG. 3 or FIG. 8, according to some examples. In operation 902, hydrogen gas is received from a supply of hydrogen, at a turbine of a turbocharger. In operation 904, excess hydrogen gas is received, from the fuel cell, at a compressor of the turbocharger. The excess hydrogen gas from the fuel cell is compressed using the compressor of the turbocharger in operation 906. As described above the turbocharger is powered in use at least in part by the hydrogen gas received from the supply of hydrogen. In operation 908, the compressed excess hydrogen gas from the compressor is returned to the fuel cell. These operations are performed under control of one or more processors in the power electronics 206 or other management system, executing relevant machine-readable instructions.

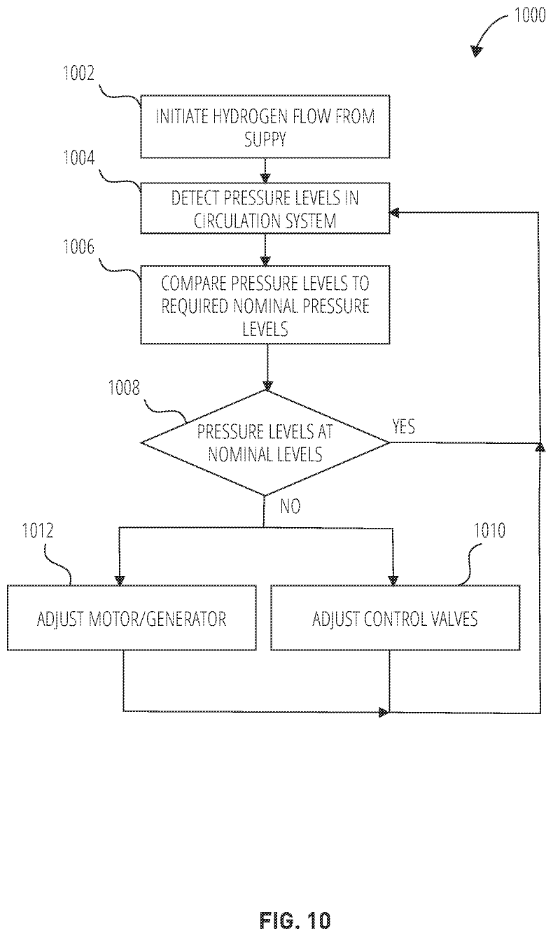

FIG. 10 is a flowchart 1000 illustrating operation of the hydrogen recirculation systems 300, 800, according to some examples. The flowchart 1000 commences at operation 1002, in which the flow of hydrogen in the recirculation system 300, 800 is initiated, such as from liquid hydrogen tank 302 and expansion system 304.

In operation 1004, the pressure levels in the supply lines of the recirculation system are detected by the power electronics 206 via signals provided by the various pressure sensors, such as pressure sensors 810, 812, 814 and 816. In operation 1006, the power electronics 206 compares the detected pressure levels with required nominal pressure levels for the recirculation system 300, 800.

In operation 1008, if the detected pressure levels are within a threshold value of the nominal pressure levels, the method returns to operation 1004 and proceeds from there. If the detected pressure levels are not within a threshold value of the nominal pressure levels, the control valves, such as control valves 324, 804, 806, control valve 808 and/or control valve 334 are adjusted in operation 1010 by signals provided by the power electronics 206. The particular adjustments will depend on the situation that is occurring, but may include fully or partially opening or closing one or more of the valves to enable, disable or adjust the functioning of one or more of the turbochargers 310, 802a, 802b and/or 802c. For example, the pressure in supply line 318 can be increased by opening control valves 804, 806 and 808, together with control valve 324. Similarly, the pressure in supply lines 320, supply line 322 can be decreased by opening control valves 804, 806 and 808.

Alternatively or in addition to the adjustment of the control valves, the operation of the generator/motor 332 is adjusted in operation 1012 by signals provided by the power electronics 206 based on the detected pressure levels. The generator/motor 332 when operated as a motor provides additional torque to the corresponding turbocharger 310, 600, 800x, which will increase the pressure of the hydrogen in the supply line 318 and/or decrease the pressure in the supply lines 320, 322. The generator/motor 332 when operated as a generator reduces the torque provided by the corresponding turbocharger 310, 600, 800x for compressing the excess hydrogen from the fuel cell, which will decrease the pressure of the hydrogen in the supply line 318 and/or increase the pressure in the supply lines 320, 322.

In some examples, the degree of opening of the control valves and operation of the generator motor 332 is coordinated across the recirculation system 300, 800 by the power electronics 206 to maintain the pressures in the supply lines within desired ranges based on the operating conditions of the aircraft 100, of the recirculation system, and environmental conditions. These operations are performed under control of one or more processors in the power electronics 206 or other management system, executing relevant machine-readable instructions. The method then returns to operation 1004 and proceeds from there.

Various examples are contemplated. Example 1 is a hydrogen circulation system for use with a fuel cell stack, comprising: a supply line for receiving hydrogen gas from a supply of hydrogen; a fuel cell for receiving hydrogen gas from the supply line; an excess hydrogen line for receiving excess hydrogen gas from the fuel cell; and a turbocharger coupled to the excess hydrogen line and the supply line, to receive excess hydrogen gas from the excess hydrogen line, compress it, and return it to the supply line, the turbocharger being powered in use at least in part by hydrogen gas from the supply line.

In Example 2, the subject matter of Example 1 includes, wherein the turbocharger receives hydrogen gas from a first location on the supply line and returns excess hydrogen gas to the supply line at a second location, further comprising a supply pressure control valve between the first and the second locations to reduce a pressure of the hydrogen gas in the supply line to a fuel cell supply pressure.

In Example 3, the subject matter of Example 2 includes, a turbocharger pressure control valve positioned between the first location and the turbocharger.

In Example 4, the subject matter of Examples 1-3 includes, a generator/motor coupled to the turbocharger and operable to retard or boost operation of the turbocharger.

In Example 5, the subject natter of Examples 1-4 includes, at least one further turbocharger coupled to the excess hydrogen line and the supply line in parallel with the turbocharger.

In Example 6, the subject matter of Examples 1-5 includes, wherein the turbocharger includes a water-lubricated bearing.

In Example 7, the subject matter of Examples 1-6 includes, wherein the turbocharger includes a gas-lubricated bearing using hydrogen gas.

In Example 8, the subject matter of Examples 1-7 includes, wherein the turbocharger has a compressor with multiple stages.

Example 9, the subject matter of Examples 1-8 includes, wherein a turbine of the turbocharger is an aeolipile.

In Example 10, the subject matter of Examples 4-9 includes, wherein a turbine of the turbocharger is an aeolipile.

Example 11 is a method of operating hydrogen circulation system for use with a fuel cell, the method comprising: receiving hydrogen gas, from a supply of hydrogen, at a turbine of a turbocharger; receiving excess hydrogen gas, from the fuel cell, at a compressor of the turbocharger; compressing the excess hydrogen gas from the fuel cell using the compressor of the turbocharger, the turbocharger being powered in use at least in part by the hydrogen gas received from the supply of hydrogen; and returning the compressed excess hydrogen gas to the fuel cell.

In Example 12, the subject matter of Example 11 includes, boosting operation of the turbocharger using a motor. In Example 13, the subject matter of Examples 11-12 includes, retarding operation of the turbocharger using a generator.

In Example 14, the subject matter of Examples 11-13 includes, wherein the hydrogen gas from the supply of hydrogen is received from a first location on a supply line and compressed excess hydrogen gas from the compressor is provided to the supply line at a second location, further comprising: controlling a pressure differential between the first location and the second location to reduce a pressure of the hydrogen gas in the supply line to a fuel cell supply pressure.

In Example 15, the subject matter of Examples 11-14 includes, controlling a pressure of the hydrogen gas from the supply of hydrogen, thereby to control a pressure of the compressed excess hydrogen gas.

In Example 16, the subject matter of Examples 11-15 includes, wherein the hydrogen gas is received by a plurality of turbochargers and the excess hydrogen gas is compressed by the plurality of turbochargers.

Example 17 is a non-transitory computer-readable storage medium storing instructions that, when executed by at least one processor, cause the at least one processor to control a hydrogen circulation system and fuel cell to perform operations comprising: receiving hydrogen gas, from a supply of hydrogen, at a turbine of a turbocharger; receiving excess hydrogen gas, from the fuel cell, at a compressor of the turbocharger; compressing the excess hydrogen gas from the fuel cell using the compressor of the turbocharger, the turbocharger being powered in use at least in part by the hydrogen gas received from the supply of hydrogen; and returning the compressed excess hydrogen gas to the fuel cell.

In Example 18, the subject matter of Example 17 includes, wherein the operations further comprise: retarding operation of the turbocharger using a generator.

In Example 19, the subject matter of Examples 17-18 includes, wherein the hydrogen gas from the supply of hydrogen is received from a first location on a supply line and compressed excess hydrogen gas from the compressor is provided to the supply line at a second location, the operations further comprising: controlling a pressure differential between the first location and the second location to reduce a pressure of the hydrogen gas in the supply line to a fuel cell supply pressure.

In Example 20, the subject matter of Examples 17-19 includes, wherein the turbocharger comprises a plurality of turbochargers and the excess hydrogen gas is compressed by the plurality of turbochargers under control of the at least one processor.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20, Example 23 is a system to implement of any of Examples 1-20, and Example 24 is a method to implement of any of Examples 1-20.

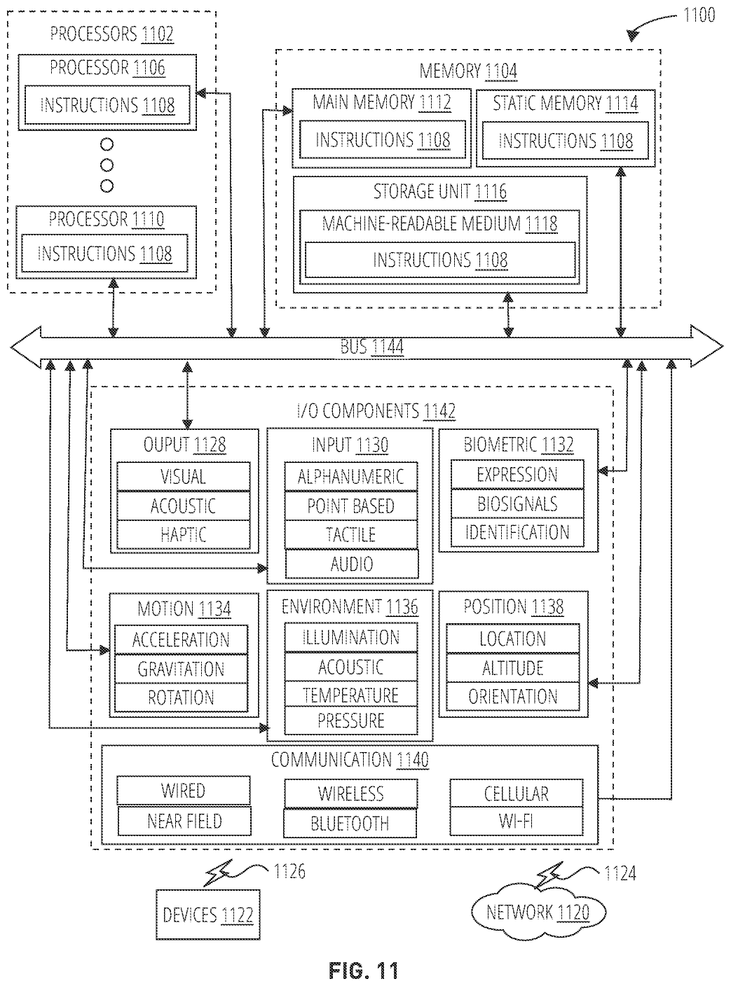

FIG. 11 illustrates a diagrammatic representation of a machine 1100 in the form of a computer system within which a set of instructions may be executed for causing the machine to perform any one or more of the methodologies discussed herein, according to an example. Specifically, FIG. 11 shows a diagrammatic representation of the machine 1100 in the example form of a computer system, within which instructions 1108 (e.g., software, a program, an application, an applet, an app, or other executable code) for causing the machine 1100 to perform any one or more of the methodologies discussed herein may be executed. The instructions 1108 transform the general, non-programmed machine 1100 into a particular machine 1100 programmed to carry out the described and illustrated functions in the manner described. In alternative examples, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1108, sequentially or otherwise, that specify actions to be taken by the machine 1100. Further, while only a single machine 1100 is illustrated, the term “machine” shall also be taken to include a collection of machines 1100 that individually or jointly execute the instructions 1108 to perform any one or more of the methodologies discussed herein.

The machine 1100 may include processors 1102, memory 1104, and I/O components 1142, which may be configured to communicate with each other such as via a bus 1144. In an example, the processors 1102 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RTIC), another processor, or any suitable combination thereof) may include, for example, a processor 1106 and a processor 1110 that may execute the instructions 1108. The term “processor” is intended to include multi-core processors that may comprise two or more independent processors (sometimes referred to as “cores”) that may execute instructions contemporaneously. Although FIG. 11 shows multiple processors 1102, the machine 1100 may include a single processor with a single core, a single processor with multiple cores (e.g., a multi-core processor), multiple processors with a single core, multiple processors with multiples cores, or any combination thereof.

The memory 1104 may include a main memory 1112, a static memory 1114, and a storage unit 1116, both accessible to the processors 1102 such as via the bus 1144. The main memory 1104, the static memory 1114, and storage unit 1116 store the instructions 1108 embodying any one or more of the methodologies or functions described herein. The instructions 1108 may also reside, completely or partially, within the main memory 1112, within the static memory 1114, within machine-readable medium 1118 within the storage unit 1116, within at least one of the processors 1102 (e.g., within the processor's cache memory), or any suitable combination thereof, during execution thereof by the machine 1100.

The I/O components 1142 may include a wide variety of components to receive input, provide output, produce output, transmit information, exchange information, capture measurements, and so on. The specific I/O components 1142 that are included in a particular machine will depend on the type of machine. For example, portable machines such as mobile phones will likely include a touch input device or other such input mechanisms, while a headless server machine will likely not include such a touch input device. It will be appreciated that the I/O components 1142 may include many other components that are not shown in FIG. 11. The I/O components 1142 are grouped according to functionality merely for simplifying the following discussion and the grouping is in no way limiting. In various examples, the I/O components 1142 may include output components 1128 and input components 1130. The output components 1128 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1130 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1142 may include biometric components 1132, motion components 1134, environmental components 1136, or position components 1138, among a wide array of other components. For example, the biometric components 1132 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that, may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1142 may include communication components 1140 operable to couple the machine 1100 to a network 1120 or devices 1122 via a coupling 1124 and a coupling 1126, respectively. For example, the communication components 1140 may include a network interface component or another suitable device to interface with the network 1120. In further examples, the communication components 1140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1122 may be another machine or any of a wide variety of peripheral devices (e.g., a peripheral device coupled via a USB).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 1104, main memory 1112, static memory 1114, and/or memory of the processors 1102) and/or storage unit 1116 may store one or more sets of instructions and data structures (e.g., software) embodying or utilized by any one or more of the methodologies or functions described herein. These instructions (e.g., the instructions 1108), when executed by processors 1102, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 1120 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1120 or a portion of the network 1120 may include a wireless or cellular network, and the coupling 1124 may be a Code Division Multiple Access (CDMA) connection, a Global System for Mobile communications (GSM) connection, or another type of cellular or wireless coupling. In this example, the coupling 1124 may implement any of a variety of types of data transfer technology, such as Single Carrier Radio Transmission Technology (1×RTT), Evolution-Data, Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide interoperability for Microwave Access (WiMAX), Long Term Evolution (LTE) standard, others defined by various standard-setting organizations, other long range protocols, or other data transfer technology.

The instructions 1108 may be transmitted or received over the network 1120 using a transmission medium via a network interface device (e.g., a network interface component included in the communication components 1140) and utilizing any one of a number of well-known transfer protocols (e.g., hypertext transfer protocol (HTTP)). Similarly, the instructions 1108 may be transmitted or received using a transmission medium via the coupling 1126 (e.g., a peer-to-peer coupling) to the devices 1122. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1108 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure, and refer to non-transitory media.

Examples of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

What is claimed is:

1. A hydrogen circulation system for use with a fuel cell stack, comprising:
a supply line for receiving hydrogen gas from a supply of hydrogen;
a fuel cell for receiving hydrogen gas from the supply line;
an excess hydrogen line for receiving excess hydrogen gas from the fuel cell; and
a turbocharger coupled to the excess hydrogen line and the supply line, to receive excess hydrogen gas from the excess hydrogen line, compress it, and return it to the supply line, the turbocharger being powered in use at least in part by hydrogen gas from the supply line.

2. The hydrogen circulation system of claim 1, wherein the turbocharger receives hydrogen gas from a first location on the supply line and returns excess hydrogen gas to the supply line at a second location, further comprising a supply pressure control valve between the first and the second locations to reduce a pressure of the hydrogen gas in the supply line to a fuel cell supply pressure.

3. The hydrogen circulation system of claim 2, further comprising a turbocharger pressure control valve positioned between the first location and the turbocharger.

4. The hydrogen circulation system of claim 1, further comprising a generator/motor coupled to the turbocharger and operable to retard or boost operation of the turbocharger.

5. The hydrogen circulation system of claim 1, further comprising:
at least one further turbocharger coupled to the excess hydrogen line and the supply line in parallel with the turbocharger.

6. The hydrogen circulation system of claim 1, wherein the turbocharger includes a water-lubricated bearing.

7. The hydrogen circulation system of claim 1, wherein the turbocharger includes a gas-lubricated bearing using hydrogen gas.

8. The hydrogen circulation system of claim 1, wherein the turbocharger has a compressor with multiple stages.

9. The hydrogen circulation system of claim 1, wherein a turbine of the turbocharger is an aeolipile.

10. The hydrogen circulation system of claim 4, wherein a turbine of the turbocharger is an aeolipile.

11. A method of operating hydrogen circulation system for use with a fuel cell, the method comprising:
receiving hydrogen gas, from a supply of hydrogen, at a turbine of a turbocharger;
receiving excess hydrogen gas, from the fuel cell, at a compressor of the turbocharger;
compressing the excess hydrogen gas from the fuel cell using the compressor of the turbocharger, the turbocharger being powered in use at least in part by the hydrogen gas received from the supply of hydrogen; and
returning the compressed excess hydrogen gas to the fuel cell.

12. The method of claim 11, further comprising:
boosting operation of the turbocharger using a motor.

13. The method of claim 11, further comprising:
retarding operation of the turbocharger using a generator.

14. The method of claim 11, wherein the hydrogen gas from the supply of hydrogen is received from a first location on a supply line and compressed excess hydrogen gas from the compressor is provided to the supply line at a second location, further comprising:
controlling a pressure differential between the first location and the second location to reduce a pressure of the hydrogen gas in the supply line to a fuel cell supply pressure.

15. The method of claim 11, further comprising:
controlling a pressure of the hydrogen gas from the supply of hydrogen, thereby to control a pressure of the compressed excess hydrogen gas.

16. The method of claim 11, wherein the hydrogen gas is received by a plurality of turbochargers and the excess hydrogen gas is compressed by the plurality of turbochargers.

17. A non-transitory computer-readable storage medium storing instructions that, when executed by at least one processor, cause the at least one processor to control a hydrogen circulation system and fuel cell to perform operations comprising:
receiving hydrogen gas, from a supply of hydrogen, at a turbine of a turbocharger;
receiving excess hydrogen gas, from the fuel cell, at a compressor of the turbocharger;
compressing the excess hydrogen gas from the fuel cell using the compressor of the turbocharger, the turbocharger being powered in use at least in part by the hydrogen gas received from the supply of hydrogen; and
returning the compressed excess hydrogen gas to the fuel cell.

18. The non-transitory computer-readable storage medium of claim 17, wherein the operations further comprise:
retarding operation of the turbocharger using a generator.

19. The non-transitory computer-readable storage medium of claim 17, wherein the hydrogen gas from the supply of hydrogen is received from a first location on a supply line and compressed excess hydrogen gas from the compressor is provided to the supply line at a second location, the operations further comprising:
controlling a pressure differential between the first location and the second location to reduce a pressure of the hydrogen gas in the supply line to a fuel cell supply pressure.

20. The non-transitory computer-readable storage medium of claim 17, wherein the turbocharger comprises a plurality of turbochargers and the excess hydrogen gas is compressed by the plurality of turbochargers under control of the at least one processor.
